(19) United States
(12) Patent Application Publication
(10) Pub. No.: US 2007/0292726 A1
(43) Pub. Date: Dec. 20, 2007

(54) Fuel Cell System And Method For Inspecting Gas Leakage Of Same

(76) Inventors: Yasuyuki Iida, Aichi (JP); Nobuo Kobayashi, Aichi (JP); Kiyoshi Yoshizumi, Aichi (JP); Hiroaki Nishiumi, Aichi (JP); Junpei Horikawa, Aichi (JP); Takeki Hayashi, Aichi (JP)

Correspondence Address: KENYON & KENYON LLP, 1500 K STREET N.W., SUITE 700, WASHINGTON, DC, 20005, US

(21) Appl. No.: 11/791,230

(22) PCT Filed: Dec. 7, 2005
(86) PCT No.: PCT/JP05/22902

§ 371 Date: May 22, 2007

(30) Foreign Application Priority Data
Dec. 7, 2004 (JP) 2004-354068
Dec. 7, 2004 (JP) 2004-354066

(51) Int. Cl. H01M 8/04

(52) U.S. Cl. 429/13; 429/34

(57) ABSTRACT

A fuel cell system of the present invention includes a fuel cell stack, a fuel system for supplying a fuel gas to the fuel cell stack, and on-off valves which form a closed space not including the fuel cell stack in the fuel system. The closed space is filled with an inspection gas from the on-off valve which functions also as an inspection gas inlet port. After completion of the inspection, the inspection gas in the closed space is discharged from the on-off valve which functions also as an inspection gas outlet port.

### BACKGROUND

The present invention relates to a fuel cell system and a method for inspecting gas leakage of the same, and more particularly to a technology effective for preventing performance deterioration of a fuel cell caused by inspecting gas leakage.

In a fuel cell system, it is very important to detect leakage of a reaction gas (a fuel gas or an oxidant gas) with accuracy. In order to respond to the demand, for example, Japanese Patent Laid-Open No. 2002-334713 discloses a method for detecting a leak rate by charging a helium gas used as an inspection gas into a fuel gas flow path or an oxidant gas flow path.

### SUMMARY

After completion of the inspection, however, the inspection gas is discharged from a fuel gas (or oxidant gas) outlet port provided in the fuel cell system, upon which the inspection gas different from the fuel gas (or oxidant gas) comes to be mixed in the fuel cell stack and it may deteriorate the performance of the fuel cell stack.

Therefore, it is an object of the present invention to provide a fuel cell system effective for preventing performance deterioration of a fuel cell caused by inspecting gas leakage and a method for inspecting the gas leakage of the same.

In order to solve the above problem, according to one aspect of the present invention, there is provided a fuel cell system comprising: a fuel cell; a gas flow path for supplying an inspection gas to the fuel cell; and closed space forming means for forming a closed space not including the fuel cell in the gas flow path, wherein the closed space has an inspection gas inlet port and an inspection gas outlet port.

According to the above configuration, the inspection gas is directly charged into the closed space not including the fuel cell via the inspection gas inlet port and directly discharged from the closed space to the outside via the inspection gas outlet port, thereby reducing the inspection gas which comes to be mixed in the fuel cell.

In the fuel cell system according to the present invention, an inspection gas discharge system which leads to the inspection gas outlet port can also include pressure reducing means for reducing the pressure of the inspection gas to a predetermined pressure or lower. According to this configuration, the inspection gas discharge pressure to the outside can be reduced to a low level.

In the fuel cell system according to the present invention, the inspection gas discharge system which leads to the inspection gas outlet port can also include collection means for collecting the inspection gas. According to this configuration, the used inspection gas can be recycled. Furthermore, the inspection gas discharge system can also include pressurizing means for pressurizing the inspection gas upstream of the collection means. According to this configuration, even if the internal pressure of the inspection gas discharge system decreases, the inspection gas can be collected in the collection means.

According to another aspect of the present invention, there is provided a method for inspecting gas leakage of the fuel cell system having one of the above configurations, comprising the steps of: forming a closed space not including a fuel cell in a gas flow path; charging an inspection gas from the inspection gas inlet port into a closed space formed in the gas flow path; and discharging the inspection gas charged in the closed space from the inspection gas outlet port to the outside.

According to the above configuration, the inspection gas is directly charged into the closed space not including the fuel cell via the inspection gas inlet port and directly discharged from the closed space to the outside via the inspection gas outlet port, thereby reducing the inspection gas which comes to be mixed in the fuel cell.

According to still another aspect of the present invention, there is provided a method for inspecting gas leakage of a fuel cell system provided with a gas flow path for supplying a reaction gas to a fuel cell, comprising the steps of: forming a closed space not including the fuel cell in the gas flow path; charging an inspection gas from an inspection gas inlet port provided in the closed space; and discharging the inspection gas from the closed space to the outside without passing it through the fuel cell.

According to the above configuration, the inspection gas is directly charged into the closed space not including the fuel cell via the inspection gas inlet port and directly discharged from the closed space to the outside without passing it through the fuel cell, thereby reducing the inspection gas which comes to be mixed in the fuel cell.

In the method for inspecting gas leakage, the inspection gas can also be discharged from the closed space via the inspection gas inlet port. According to this configuration, it is possible to achieve sharing between the charge system and the discharge system for the inspection gas.

In the method for inspecting gas leakage, the inspection gas discharged from the closed space can also be reduced in pressure to a predetermined pressure or lower.

According to this configuration, the inspection gas discharge pressure to the outside can be reduced to a low level.

In the method for inspecting gas leakage, the inspection gas discharged from the closed space can also be collected. According to this configuration, the used inspection gas can be recycled. Furthermore, the inspection gas discharged from the closed space can also be pressurized and collected in a tank. According to this configuration, even if the internal pressure of the inspection gas discharge system decreases to lower than the internal pressure of the tank, the inspection gas can be collected in the tank.

According to still another aspect of the present invention, there is provided a fuel cell system provided with a gas flow path for supplying a reaction gas to a fuel cell, comprising: a plurality of shut-off valves provided in the gas flow path and an inspection gas unit for supplying an inspection gas to the gas flow path and discharging it from the gas flow path, wherein the inspection gas unit is connected to the gas flow path in a section enclosed by the shut-off valves.

In the above configuration, the closed space not including the fuel cell is formed in the gas flow path by closing the shut-off valves. The inspection gas can be directly charged into the closed space from the inspection gas unit connected to the closed space. In addition, after completion of the inspection, the inspection gas can be directly discharged from the closed space to the outside without passing it through the fuel cell. This reduces the inspection gas which comes to be mixed in the fuel cell.

### DESCRIPTION OF DRAWINGS

FIG. 1 is a system configuration diagram showing a part of a fuel cell system according to a first embodiment of the present invention and an inspection gas controller for inspecting gas leakage of the fuel cell system with being connected to the fuel cell system;

FIG. 2 is a flowchart showing a procedure for inspecting gas leakage in the system configuration shown in FIG. 1;

FIG. 3 is a main part enlarged view of FIG. 1 showing a condition in which an inspection gas is charged into a closed space;

FIG. 4 is a main part enlarged view of FIG. 1 showing a condition in which the inspection gas is discharged from the closed space;

FIG. 5 is a system configuration diagram according to a second embodiment of the present invention showing a part of a fuel cell system to be a target of gas leakage inspection and an inspection gas controller for inspecting gas leakage of the fuel cell system with being connected to the fuel cell system;

FIG. 6 is a flowchart showing a procedure for inspecting gas leakage in the system configuration shown in FIG. 5;

FIG. 7 is a main part enlarged view of FIG. 5 showing a condition in which an inspection gas is charged into a closed space;

FIG. 8 is a main part enlarged view of FIG. 5 showing a condition in which the inspection gas is discharged from the closed space;

FIG. 9 is a system configuration diagram according to a third embodiment of the present invention showing a part of a fuel cell system to be a target of gas leakage inspection and an inspection gas controller for inspecting gas leakage of the fuel cell system with being connected to the fuel cell system;

FIG. 10 is a flowchart showing a procedure for inspecting gas leakage in the system configuration shown in FIG. 9;

FIG. 11 is a main part enlarged view of FIG. 9 showing a condition in which an inspection gas is charged into a closed space; and

FIG. 12 is a main part enlarged view of FIG. 9 showing a condition in which the inspection gas is discharged from the closed space.

### DETAILED DESCRIPTION

Preferred embodiments of the present invention will be described below with reference to accompanying drawings. A fuel cell system according to the present invention is applicable to a stationary fuel cell system or the like as well as a fuel cell system mounted on a movable body such as an electric car.

### First Embodiment

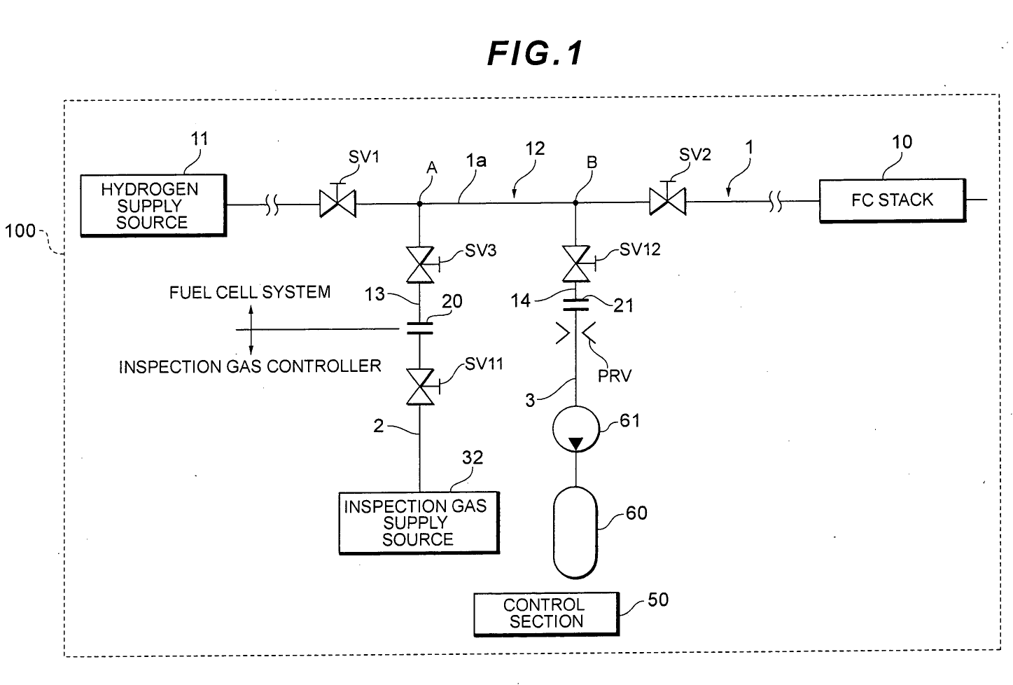

FIG. 1 is a system configuration diagram showing a part of a fuel cell system to be a target of gas leakage inspection and an inspection gas controller for inspecting gas leakage of the fuel cell system with being connected to the fuel cell system.

As shown in FIG. 1, a fuel cell system 100 includes a system for supplying a hydrogen gas as a fuel gas to a fuel cell stack (fuel cell) 10 (hereinafter, referred to as the fuel system 1) and a system (not shown) for supplying an air as an oxidant gas. The fuel cell stack 10 has a stack structure of a plurality of cells stacked on top of each other, each of which is composed of a membrane electrode assembly (MEA) interposed between a pair of separators each having hydrogen gas, air, and coolant flow paths.

A fuel system (gas flow path) 1 for supplying the hydrogen gas to the fuel cell stack 10 includes a hydrogen supply source 11, an on-off valve SV1, and an on-off valve SV2, which are disposed at predetermined intervals.

Furthermore, an on-off valve SV3 and an on-off valve SV12 are disposed in the middle of pipes 13 and 14 branching at branching portions A and B of a pipe 1a sectioned by the on-off valves SV1 and SV2, respectively.

These on-off valves SV1 to SV3 and SV12 function as closed space forming means for forming a closed space 12 which does not include the fuel cell stack 10 on the upstream side of the fuel cell stack 10 of the fuel system 1. Furthermore, the on-off valve SV3 is for use in controlling whether to start or stop charging the inspection gas into the closed space 12 and functions as an inspection gas inlet port. On the other hand, the on-off valve SV12 is for use in controlling whether to start or stop discharging the inspection gas from the closed space 12 and functions as an inspection gas outlet port.

The pipe 13 is connected to an inspection gas charge system 2 for use in charging the inspection gas into the closed space 12 from the inspection gas controller side via a connector 20. The inspection gas charge system 2 includes, in order from the connector 20 side, an on-off valve SV11 and an inspection gas supply source 32 and the like.

On the other hand, the pipe 14 is connected to an inspection gas discharge system 3 for use in discharging the inspection gas in the closed space 12 to the outside via a connector 21. In other words, the inspection gas discharge system 3 leads to the on-off valve SV12 which functions as the inspection gas outlet port via a part of the pipe 14 (between the on-off valve SV12 and the connector 21).

The inspection gas discharge system 3 includes, in order from the connector 21 side, pressure reducing means PRV, a pump (pressurizing means) 61 for pressurizing the inspection gas from the closed space 12 and pressure-feeding it to a storage tank (collection means) 60, and the storage tank 60 for collecting the inspection gas. The pressure reducing means PRV has a function of controlling (reducing) the pressure of the inspection gas discharged from the closed space 12 to a predetermined pressure. For example, an orifice or a regulating valve can be used as the pressure reducing means PRV.

A control section 50 controls the opening and closing of the on-off valves SV1 to SV3, SV11, and SV12, the operation of the pump 61, and the start and stop of supplying the inspection gas from the inspection gas supply source 32.

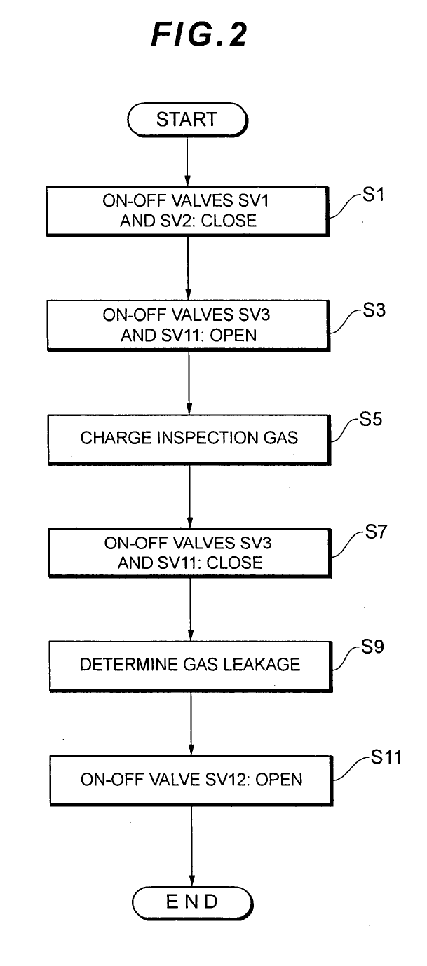

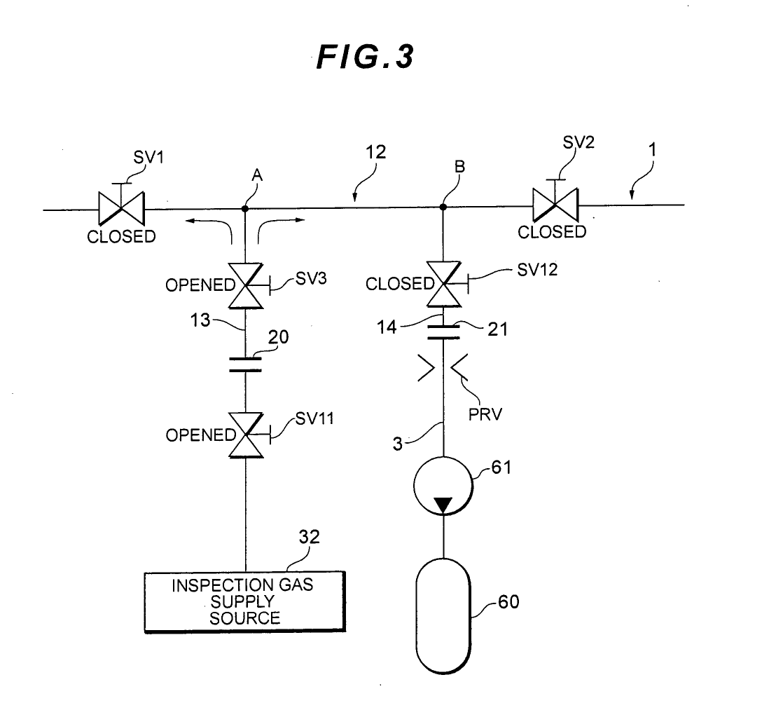

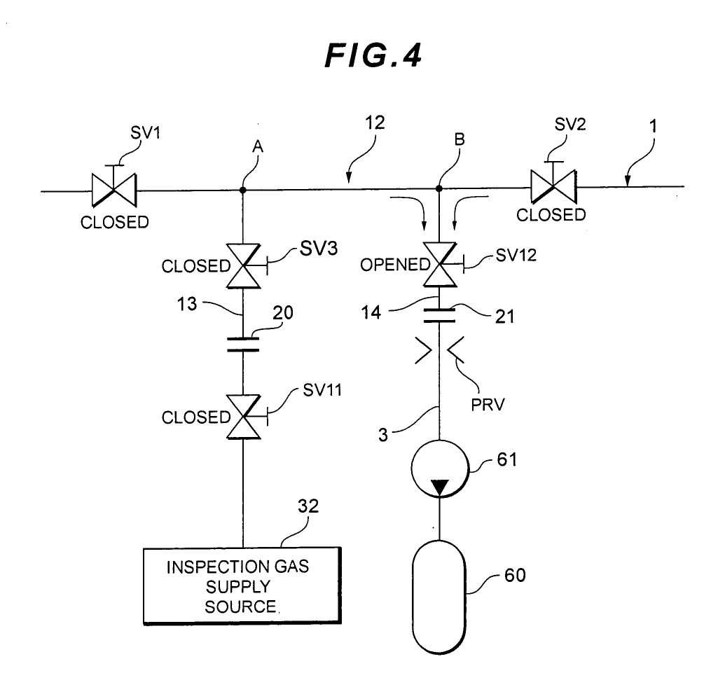

Subsequently, a method for inspecting gas leakage according to this embodiment will be described with reference to the flowchart shown in FIG. 2. Also, FIG. 3 and FIG. 4 will be referenced, if necessary, in this description. It is assumed that the on-off valves SV3, SV11, and SV12 are previously closed.

First, the on-off valves SV1 and SV2 are closed (step S1) to form the closed space 12 not including the fuel cell stack 10 among the on-off valves SV1 to SV3 and the on-off valve SV12 of the fuel system 1. Thereafter, the on-off valve SV3 of the pipe 13 and the on-off valve SV11 of the inspection gas charge system 2 are opened (step S3) and the inspection gas from the inspection gas supply source 32 is introduced (charged) into the closed space 12.

Thereby, as indicated by the solid arrows in FIG. 3, an inspection gas is introduced into the closed space 12 from the on-off valve SV3 (the inspection gas inlet port) disposed in the closed space 12. Thereafter, the on-off valves SV3 and SV11 are closed (step S7) to determine gas leakage of the closed space 12 (step S9) by, for example, monitoring a detected value of a pressure sensor, which is not shown, disposed in the closed space 12. After completion of the gas leakage determination, the on-off valve SV12 is opened (step S11). Thereupon, the inspection gas charged into the closed space 12 is discharged from the closed space 12 via the on-off valve SV12 (the inspection gas outlet port) as indicated by the solid arrows in FIG. 4 due to a differential pressure ΔP (=P1−P2>0) between an internal pressure P1 of the closed space 12 and an internal pressure P2 of a portion on the pump 61 side of the on-off valve SV12 in the pipe 14. The discharged inspection gas is controlled at (reduced in pressure to) a predetermined pressure by the pressure reducing means PRV and then is collected by the pump 61 into the storage tank 60 without passing through the fuel cell stack 10.

As described hereinabove, according to this embodiment, the inspection gas is directly charged into the closed space 12, which does not include the fuel cell stack 10, via the on-off valve SV3 and is directly discharged from the closed space 12 to the outside via the on-off valve SV12 without passing through the fuel cell stack 10. Thus, the inspection gas does not reach the fuel cell stack 10. Therefore, it is possible to effectively prevent the performance deterioration of the fuel cell stack 10 caused by inspecting gas leakage.

Furthermore, the inspection gas discharged from the closed space 12 is collected in the storage tank 60 in this embodiment, and therefore the used inspection gas can be recycled. Moreover, even if the internal pressure of a portion on the connector 21 side of the on-off valve SV12 of the pipe 14 and that of the inspection gas discharge system 3 decrease to lower than the internal pressure of the tank, it is possible to collect the inspection gas in the storage tank 60 by pressurizing it by the pump 61. Therefore, the recovery rate increases and the inspection cost can be reduced.

### Second Embodiment

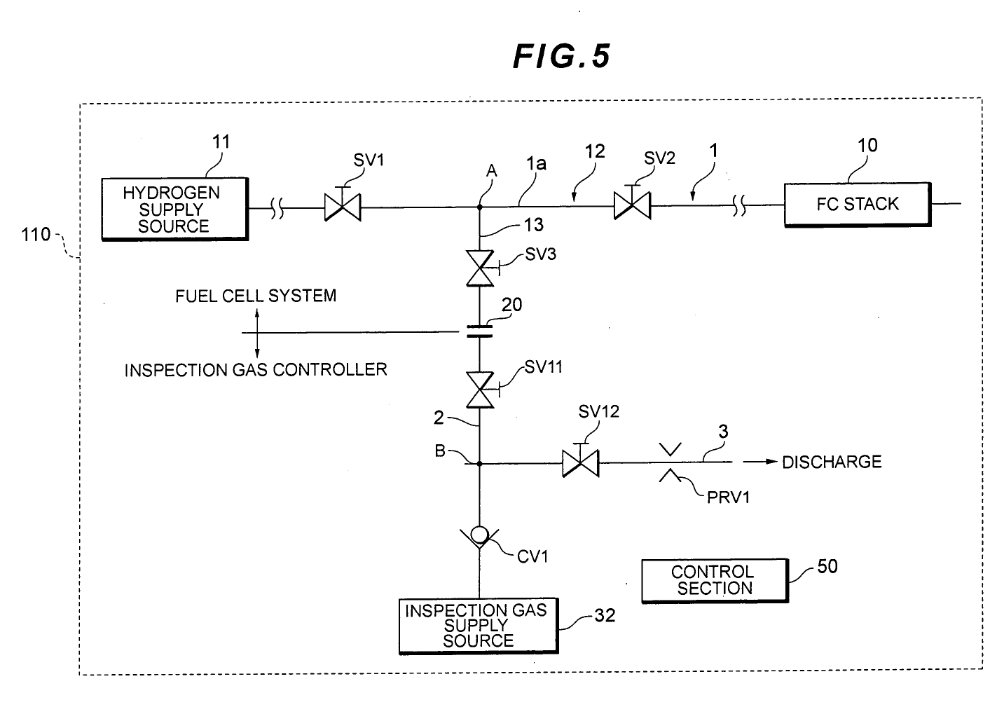

FIG. 5 is a system configuration diagram showing a part of a fuel cell system related to a method for inspecting gas leakage according to a second embodiment and an inspection gas controller (an inspection gas unit) connected thereto.

As shown in FIG. 5, a fuel cell system 110 includes a system for supplying a hydrogen gas as a fuel gas to the fuel cell stack (fuel cell) 10 (hereinafter, referred to as the fuel system 1) and a system (not shown) for supplying air as an oxidant gas. The fuel cell stack 10 has a stack structure of a plurality of cells stacked on top of each other, each of which is composed of a membrane electrode assembly (MEA) interposed between a pair of separators each having hydrogen gas, air, and coolant flow paths.

The fuel system (gas flow path) 1 for supplying the hydrogen gas to the fuel cell stack 10 includes a hydrogen supply source 11, an on-off valve (shut-off valve) SV1, and an on-off valve (shut-off valve) SV2, which are disposed at predetermined intervals. Furthermore, an on-off valve (shut-off valve) SV3 is disposed in the middle of a pipe (gas flow path) 13 branching at a branching portion A of a pipe 1a sectioned by the on-off valves SV1 and SV2.

These on-off valves SV1 to SV3 function as closed space forming means for forming a closed space 12 which does not include the fuel cell stack 10 with being located upstream of the fuel cell stack 10 of the fuel system 1. Furthermore, the on-off valve SV3 is for use in controlling whether to start or stop charging the inspection gas into the closed space 12 and to start or stop discharging the inspection gas from the closed space 12 and functions as an inspection gas inlet port and as an inspection gas outlet port.

The pipe 13 is connected at an end on the side opposite to the branching portion A to an inspection gas charge system 2 on the inspection gas controller side via a connector 20. The inspection gas charge system 2 includes, in order from the connector 20 side, an on-off valve SV11, a one-way valve CV1, an inspection gas supply source 32, and the like. The one-way valve CV1 allows the gas only to flow from the inspection gas supply source 32 side to the closed space 12 side and inhibits the gas to flow in the opposite direction, and, for example, a return check valve can be used as the one-way valve CV1.

Furthermore, an inspection gas discharge system 3 is connected in the middle of the inspection gas charge system 2, more specifically, between the on-off valve SV11 and the return check valve CV1. The inspection gas discharge system 3 includes, in order from a joint B side, a shut-off valve SV12 and pressure reducing means PRV1. The pressure reducing means PRV1 has a function of reducing the pressure of the inspection gas discharged from the closed space 12 to a predetermined pressure or lower, and, for example, an orifice, a regulating valve, or the like can be used as the pressure reducing means PRV1.

As described above, the pipe 13 functions as a part of an inspection gas charge path for introducing the inspection gas from the inspection gas controller side into the closed space 12 and as a part of an inspection gas discharge path for discharging the inspection gas in the closed space 12 to the outside.

The control section 50 controls the opening and closing of the on-off valves SV1 to SV3 and the on-off valves SV11 and SV12 and the start and stop of supplying the inspection gas from the inspection gas supply source 32.

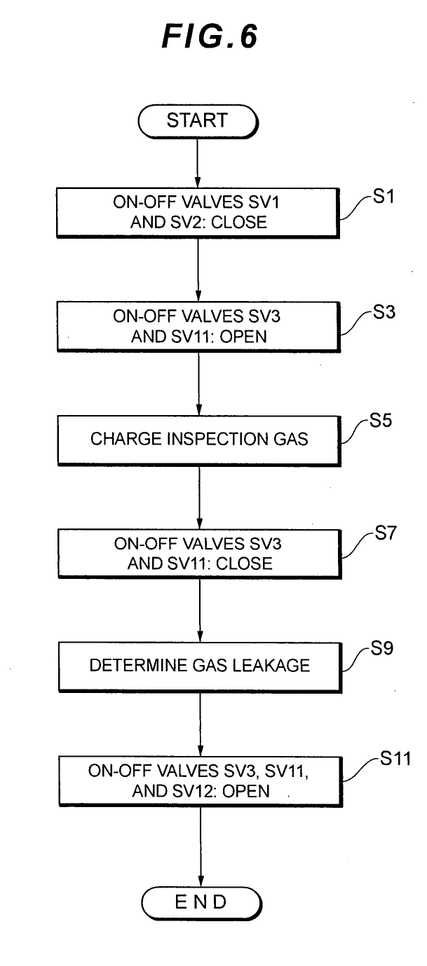

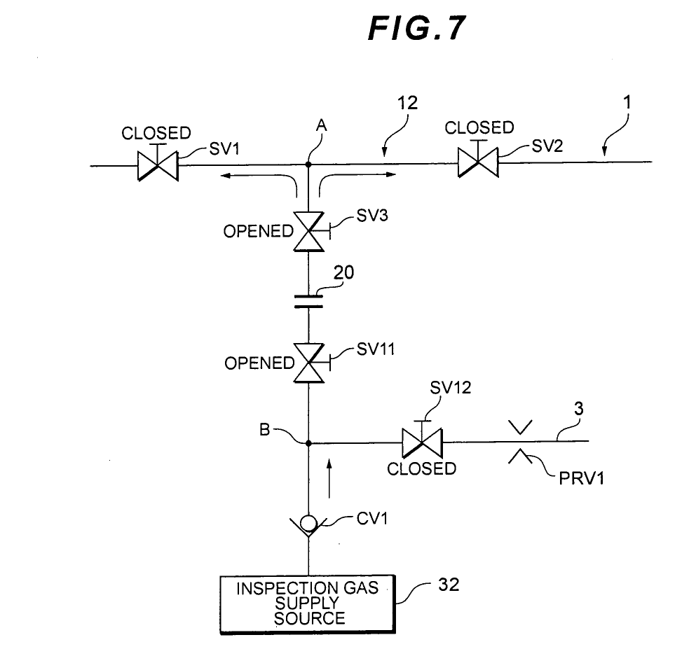

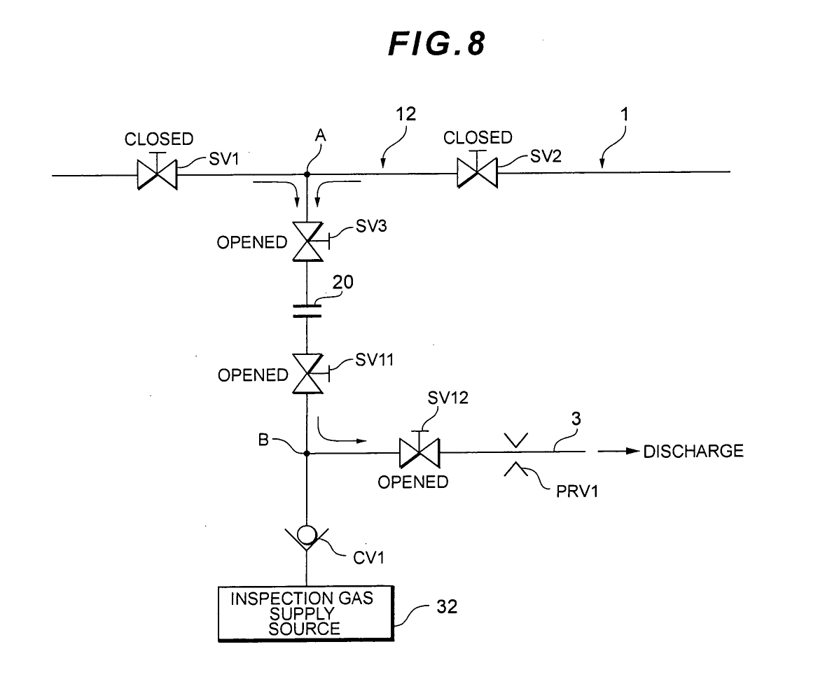

Subsequently, a method for inspecting gas leakage according to this embodiment will be described below with reference to the flowchart shown in FIG. 6. In this description, FIG. 7 and FIG. 8 will also be referenced, if necessary. The on-off valves SV3, SV1, and SV12 are assumed to be closed.

First, the on-off valves SV1 and SV2 are closed (step S1) to form the closed space 12 which does not include the fuel cell stack 10 in the section enclosed by the on-off valves SV1 to SV3 of the fuel system 1. Thereafter, the on-off valve SV3 of the pipe 13 and the on-off valve SV1 of the inspection gas charge system 2 are opened (step S3) and the inspection gas from the inspection gas supply source 32 is introduced (charged) into the closed space 12 (step S5).

Thereupon, as indicated by the solid arrows in FIG. 7, the inspection gas is introduced into the closed space 12 from the on-off valve SV3 (the inspection gas inlet port) disposed in the closed section 12. Thereafter, the on-off valves SV3 and SV11 are closed (step S7) to determine gas leakage of the closed section 12 (step S9) by, for example, monitoring a detected value of a pressure sensor, which is not shown, disposed in the closed section 12. After completion of the gas leakage determination, the on-off valves SV3, SV11, and SV12 are opened (step S1).

Thereby, the inspection gas charged into the closed space 12 is discharged from the closed space 12 via the on-off valve SV3 (the inspection gas inlet port) as indicated by the solid arrows in FIG. 8 due to a differential pressure ΔP (=P1−P2>0) between an internal pressure P1 of the closed space 12 and an internal pressure P2 of the inspection gas discharge system 3, runs through the inspection gas discharge system 3, and is released to the outside without passing through the fuel cell stack 10. At this point, the inspection gas released to the outside is controlled to a low pressure and low velocity by the pressure reducing means PRV1 and therefore it has little effect on the outside.

As described hereinabove, according to this embodiment, the inspection gas is directly charged into the closed space 12, which does not include the fuel cell stack 10, via the on-off valve SV3 and is directly discharged from the closed space 12 to the outside via the on-off valve SV3 without passing through the fuel cell stack 10. Therefore, the inspection gas does not reach the fuel cell stack 10. Therefore, it is possible to effectively prevent the performance deterioration of the fuel cell stack 10 caused by inspecting gas leakage.

Furthermore, the on-off valve SV3 functions not only as the inspection gas inlet port, but as the inspection gas outlet port, by which a part of the charge system for charging the inspection gas into the closed space 12 can also be used as a part of the discharge system for discharging the inspection gas from the closed space 12. Therefore, the system configuration can be simplified.

### Third Embodiment

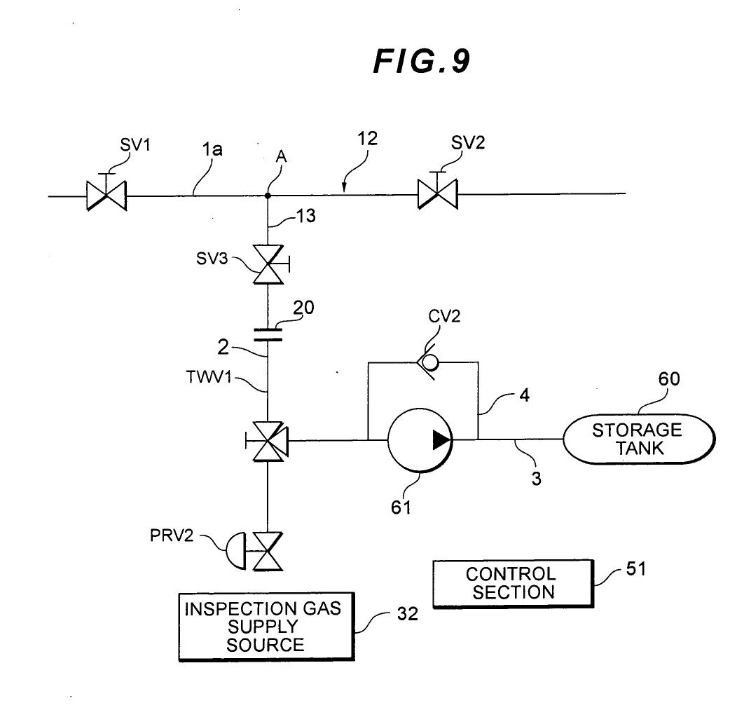

FIG. 9 is a system configuration diagram showing a part of a fuel cell system related to a method for inspecting gas leakage according to a third embodiment and an inspection gas controller connected thereto. The same reference numerals denote the same or similar constituent elements as or to those of the second embodiment (FIG. 5), with their description omitted. The following description will focus on different parts.

As shown in FIG. 9, the inspection gas charge system 2 on the inspection gas controller side includes, in order from the connector 20 side, a three-way valve TWV1 and a pressure reducing (regulating) valve PRV2, with the three-way valve TWV1 being connected to one end of an inspection gas discharge system 3. The other end (on the release side) of the inspection gas discharge system 3 is connected to a storage tank 60 for collecting the inspection gas.

As well as the storage tank 60, the inspection gas discharge system 3 includes a pump 61 for pressurizing the inspection gas from the closed space 12 and pressure-feeding it to the storage tank 60, a bypass system 4 for bypassing the pump 61, and a one-way valve CV2 disposed in the bypass system 4. The one-way valve CV2 allows the gas only to flow from the closed space 12 side to the storage tank 60 side and inhibits the gas to flow in the opposite direction, and, for example, a return check valve can be used as the one-way valve CV2.

A control section 51 controls the opening and closing of the on-off valves SV1 to SV3 and the three-way valve TWV1, the revolutions per minute (RPM) of the pump 61, and the start and stop of supplying the inspection gas from the inspection gas supply source 32.

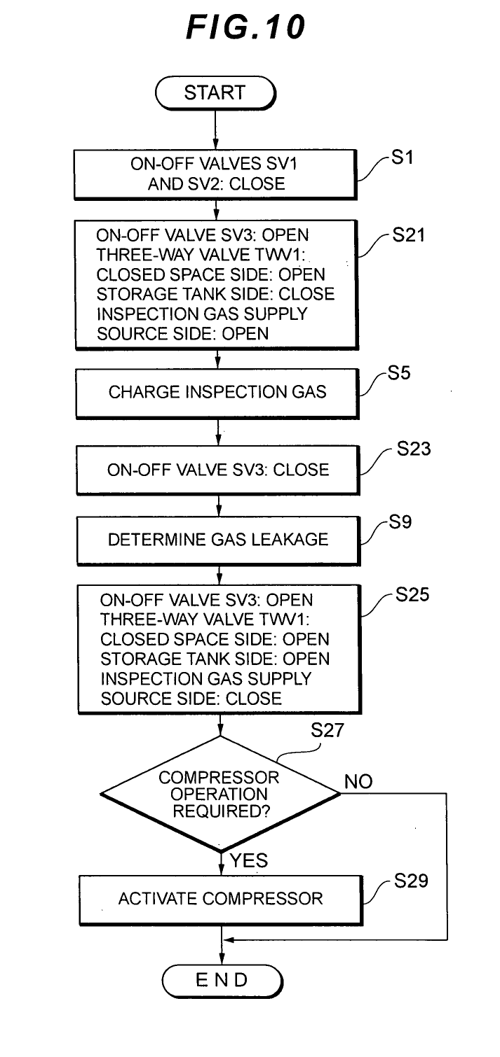

Subsequently, a method for inspecting gas leakage according to this embodiment will be described with reference to the flowchart shown in FIG. 10.

First, the on-off valves SV1 and SV2 are closed (step S1) to form the closed space 12 which does not include the fuel cell stack 10 in the section enclosed by the on-off valves SV1 to SV3 of the fuel system 1. Subsequently, the on-off valve SV3 of the pipe 13 and a flow path of the three-way valve TWV1 from the inspection gas supply source 32 side to the closed space 12 side in the inspection gas charge system 2 are opened, while the flow path to the storage tank 60 side is closed (step S21), and the inspection gas from the inspection gas supply source 32 is introduced (charged) into the closed space 12 (step S5).

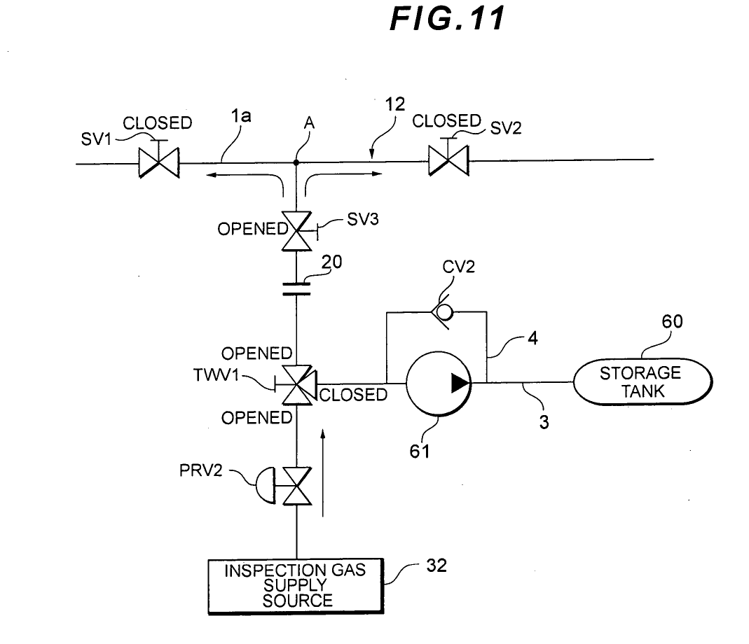

Thereby, as indicated by the solid arrows in FIG. 11, the inspection gas reduced in pressure (pressure regulated) to a predetermined pressure by the pressure reducing valve PRV2 and supplied from the inspection gas supply source 32 is introduced into the closed space 12 from the on-off valve SV3 (the inspection gas inlet port) disposed in the closed section 12. Thereafter, the on-off valve SV3 is closed (step S23) to determine gas leakage of the closed section 12 (step S9) by, for example, monitoring a detected value of a pressure sensor, which is not shown, disposed in the closed section 12.

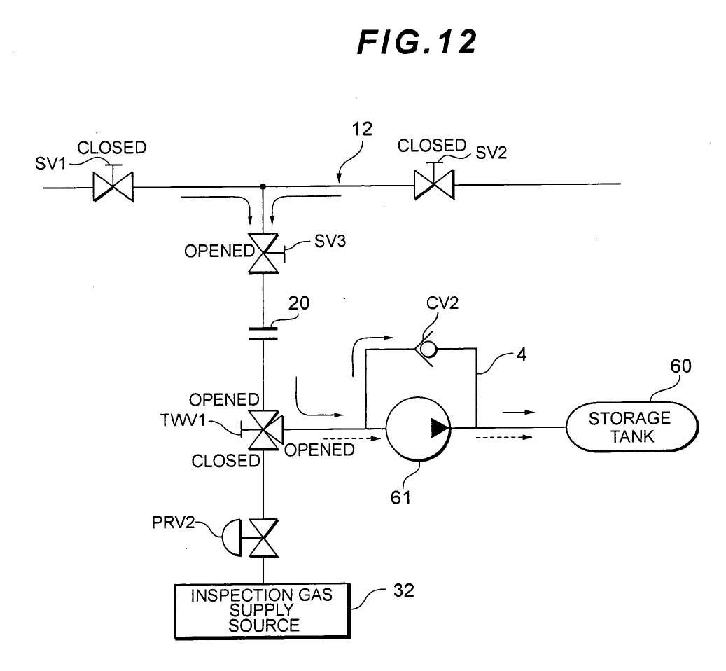

After completion of the gas leakage determination, the on-off valve SV3 is opened, the flow path of the three-way valve TWV1 from the closed space 12 side to the storage tank 60 side is opened, and the flow path to the inspection gas supply source 32 side is closed (step S25). Thereby, the inspection gas charged in the closed space 12 is discharged from the closed space 12 via the on-off valve SV3 (the inspection gas inlet port) as indicated by the solid arrows in FIG. 12 due to a differential pressure between an internal pressure of the closed space 12 and an internal pressure of the inspection gas discharge system 3. The inspection gas is then introduced into the inspection gas discharge system 3.

The inspection gas introduced into the inspection gas discharge system 3 passes through the bypass system 4 so as to be collected in the storage tank 60. In other words, the inspection gas in the closed space 12 is discharged from the closed space 12 and collected in the storage tank 60 without passing through the fuel cell stack 10. When the collection proceeds and the pipe pressure of the inspection gas discharge system 3 decreases and thereby the operation of the pump 61 is required (step S27: YES), the pump 61 is activated (step S29) to pressurize the inspection gas to collect it in the storage tank 60 as indicated by the dashed arrows in FIG. 12. The determination in step S27 is based on, for example, a detected value of a pressure sensor, which is not shown, disposed in a proper place of the inspection gas discharge system 3.

As described hereinabove, also according to this embodiment, it is possible to effectively prevent performance deterioration of the fuel cell stack 10 caused by inspecting gas leakage and to simplify the system configuration by sharing between a part of the charge system for charging the inspection gas into the closed space 12 and a part of the discharge system for discharging the inspection gas from the closed space 12.

In addition to the above, the inspection gas discharged from the closed space 12 is collected in the storage tank 60 in this embodiment, and therefore the used inspection gas can be recycled. Furthermore, even if the internal pressure of the inspection gas discharge system decreases to lower than the internal pressure of the tank, it is possible to collect the inspection gas in the storage tank 60 by pressurizing it by the pump 61. Therefore, the recovery rate increases and the inspection cost can be reduced.

Although the embodiments of the present invention have been described in detail hereinabove with reference to the drawings, specific configurations are not limited to these embodiments, but it will be apparent that a configuration with any design change or the like within a range not departing from the gist of the present invention is also included in the scope of the present invention. For example, although the closed space 12 has been formed upstream of the fuel cell stack of the fuel system 1 in each of the above embodiments, it can be formed in any other portion of the fuel system 1 or in an air supply system only if the closed space does not contain the fuel cell stack 10.

According to the present invention, the inspection gas does not reach the fuel cell during the gas leakage inspection. Therefore, it is possible to effectively prevent performance deterioration of the fuel cell caused by inspecting gas leakage. In addition, the used inspection gas can be collected and recycled, whereby the inspection cost can also be reduced. Consequently, the present invention is widely applicable to a fuel cell system having these demands and to a method for inspecting gas leakage thereof.

1. A fuel cell system comprising:
a fuel cell;
a gas flow path for supplying an inspection gas to the fuel cell; and
closed space forming means for forming a closed space not including the fuel cell in the gas flow path,
wherein the closed space has an inspection gas inlet port and an inspection gas outlet port.

2. A fuel cell system according to claim 1, wherein an inspection gas discharge system which leads to the inspection gas outlet port includes pressure reducing means for reducing the pressure of the inspection gas to a predetermined pressure or lower.

3. A fuel cell system according to claim 1, wherein the inspection gas discharge system which leads to the inspection gas outlet port includes collection means for collecting the inspection gas.

4. A fuel cell system according to claim 3, wherein the inspection gas discharge system includes pressurizing means for pressurizing the inspection gas upstream of the collection means.

5. A method for inspecting gas leakage of the fuel cell system according to claim 1, comprising the steps of:
forming a closed space not including a fuel cell in a gas flow path;
charging an inspection gas from the inspection gas inlet port into a closed space formed in the gas flow path; and
discharging the inspection gas charged in the closed space from the inspection gas outlet port to the outside.

6. A method for inspecting gas leakage of a fuel cell system provided with a gas flow path for supplying a reaction gas to a fuel cell, comprising the steps of:
forming a closed space not including the fuel cell in the gas flow path;
charging an inspection gas from an inspection gas inlet port provided in the closed space; and
discharging the inspection gas from the closed space to the outside without passing it through the fuel cell.

7. A method for inspecting gas leakage of a fuel cell system according to claim 6, wherein the inspection gas is discharged from the closed space via the inspection gas inlet port.

8. A method for inspecting gas leakage of a fuel cell system according to claim 6, wherein the inspection gas discharged from the closed space is reduced in pressure to a predetermined pressure or lower.

9. A method for inspecting gas leakage of a fuel cell system according to claim 6, wherein the inspection gas discharged from the closed space is collected.

10. A method for inspecting gas leakage of a fuel cell system according to claim 9, wherein the inspection gas discharged from the closed space is pressurized and collected in a tank.

11. A fuel cell system provided with a gas flow path for supplying a reaction gas to a fuel cell, comprising: a plurality of shut-off valves provided in the gas flow path and an inspection gas unit for supplying an inspection gas to the gas flow path and discharging it from the gas flow path, wherein the inspection gas unit is connected to the gas flow path in a section enclosed by the shut-off valves.
